(19) United States
(12) Patent Application Publication
(10) Pub. No.: US 2014/0250285 A1
(43) Pub. Date: Sep. 4, 2014

(54) INTER-DOMAIN MEMORY COPY METHOD AND APPARATUS

(71) Applicant: Samsung Electronics Co., Ltd., Gyeonggi-do (KR)

(72) Inventors: Taiho Yoon, Gyeonggi-do (KR); Indae Ha, Gyeonggi-do (KR)

(73) Assignee: Samsung Electronics Co., Ltd., Gyeonggi-do (KR)

(21) Appl. No.: 14/197,007

(22) Filed: Mar. 4, 2014

(30) Foreign Application Priority Data
Mar. 4, 2013 (KR) 10-2013-0022657

(51) Int. Cl. G06F 3/06

(52) U.S. Cl. CPC G06F 3/0647; G06F 3/0604; G06F 3/0671; G06F 3/0638
USPC 711/165

(57) ABSTRACT

A method, apparatus, and system for moving data between memory domains of the processes having independent address spaces include receiving a signal including at least one of a source address of a memory where data to be transferred is written, a destination address of the memory where the data is to be written, and a size of the data from a main processor which control a transmission domain, reading the data from the memory based on the received signal, and writing the read data on the memory based on the received signal.

### CROSS-REFERENCE TO RELATED APPLICATION(S) AND CLAIM OF PRIORITY

The present application is related to and claims the benefit under 35 U.S.C. §119(a) of a Korean patent application filed on Mar. 4, 2013 in the Korean Intellectual Property Office and assigned Serial No. 10-2013-0022657, the entire disclosure of which is hereby incorporated by reference.

### TECHNICAL FIELD

The present disclosure relates to a method, apparatus, and system for memory copy for data transmission/reception between domains of a computing device. In more particular, the present disclosure relates to a method, apparatus, and system for moving data between memory domains of the processes having independent address spaces.

### BACKGROUND

The conventional multi-core processor operates in the form of Symmetric Multi-Processing (SMP) of a plurality of cores or dedicating to a specific core based on Affinity.

The processes running on the processor maintain independent address space such that Inter-Process Communication (IPC) has been implemented with various technologies such as Shared Memory, Socket, PIPE, First In First Out (FIFO), and Message Queue (MSGQ).

Although the IPC methods show performance differences to some extent, the memory copy is an inevitable operation for them in order to implement a communication between processes.

However, the memory copy occurring frequently in the high speed data processing operation consumes Central Processing Unit (CPU) utilization, resulting in degradation of entire throughput.

### SUMMARY

To address the above-discussed deficiencies, it is a primary object to provide a method and apparatus that is capable of reducing CPU utilization by simplifying the memory copy process and improving entire system throughput.

In accordance with an aspect of the present disclosure, a method for an engine processor of a computing device to support data communication on a domain is provided. the method includes receiving a signal including at least one of a source address of a memory where data to be transferred is written, a destination address of the memory where the data is to be written, and a size of the data from a main processor which control a transmission domain, reading the data from the memory based on the received signal, and writing the read data on the memory based on the received signal.

In accordance with another aspect of the present disclosure, an engine processor supporting data communication on a domain in a computing device is provided. The engine processor includes a receiver which receives a signal including at least one of a source address of a memory where data to be transferred is written, a destination address of the memory where the data is to be written, and a size of the data from a main processor which control a transmission domain, a controller which controls the receiver to read data from the memory based on the received signal, and a transmitter which writes the read data on the memory based on the received signal.

In accordance with another aspect of the present disclosure, an inter-domain data communication method in a computing device including a main processor for controlling domains and an engine processor for supporting data communication is provided. The inter-domain data communication method includes determining data to be transmitted by the main processor controlling a transmission domain, transmitting a signal including at least one of a source address of a memory where data to be transferred is written, a destination address of the memory where the data is to be written, and a size of the data from the main processor to the engine processor, reading, at the engine processor, the data from the memory based on the received signal, writing the data read by the engine processor on the memory based on the received signal, and reading, at the main processor, the data written by the engine processor on the memory.

In accordance with another aspect of the present disclosure, a computing device supporting data communication between a plurality of domains is provided. The computing device includes a memory which stores data, a main processor which controls at least one of a transmission domain and a reception domain, and an engine processor which performs at least one of reading data stored in the memory or wiring the data on the memory based on a signal received from the main processor, wherein the main processor controlling the transmission domain determines the data to be transmitted from the main domain and transmits to the engine processor a signal including at least one of a source address of a memory where the data to be transferred is written, a destination address of the memory where the data is to be written, and a size of the data; and the engine processor reads the data from the memory based on the received signal and writes the read data on the memory based on the received signal; and the main processor controlling the reception domain reads the data written by the engine processor on the memory.

In accordance with still another aspect of the present disclosure, a processor device supporting data communication among a plurality of domains is provided. The processor device includes a transmission main processor which control a transmission domain and at least one transmission threads, a memory which is capable of being accessed by the main processor and storing data, an engine processor which a signal including at least one of a source address of a memory where data to be transferred is written, a destination address of the memory where the data is to be written, and a size of the data from a main processor which control a transmission domain, reads data from the memory based on the received signal, and write the read data on the memory based on the received signal, and a reception main processor which controls a reception domain to read the data written on the memory and at least one reception thread.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of data communication between domains in a computing device;

FIG. 2 illustrates a diagram of an inter-domain communication system according to an embodiment of the present disclosure;

FIG. 3 illustrates a diagram of an inter-thread communication system according to another embodiment of the present disclosure;

FIG. 4 illustrates a block diagram of a configuration of the computing device according to an embodiment of the present disclosure;

FIG. 5 illustrates a process of the operation procedure of the processor according to an embodiment of the present disclosure; and

FIG. 6 illustrates a signal flow diagram of signal flows among the components according to an embodiment of the present disclosure.

### DETAILED DESCRIPTION

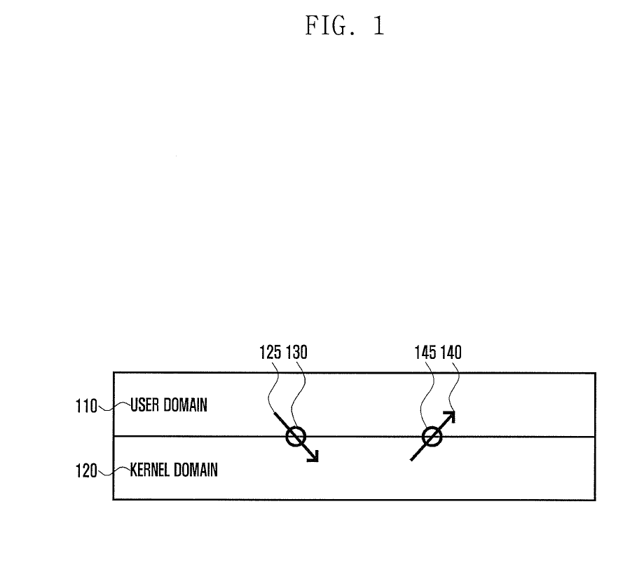

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system and method. Example embodiments of the present disclosure are described with reference to the accompanying drawings in detail.

Detailed description of well-known functions and structures incorporated herein may be omitted to avoid obscuring the subject matter of the present disclosure. This aims to omit unnecessary description so as to make the subject matter of the present disclosure clear.

FIG. 1 illustrates a diagram of data communication between domains in a computing device.

Referring to FIG. 1, the communication between applications operating in the user domain may be composed of the first data movement 125 from the user domain 110 to the kernel domain 120 and the second data movement from the kernel domain 120 to the user domain 110.

The first data movement 125 may include a phase for the first application transfers the data to the kernel domain 120 for data transmission. For the first data movement 125, the first data copy 130 is used. The first data copy 130 may include a phase for the main processor to access the memory storing the data to be transmitted and copy the data. The main processor may copy paste the copied data in the memory which the destination process or application can access. This is described hereinafter.

The process may perform at least one of integrity test and encryption to verify the validity of the data based on the transmitted data.

The process may perform the second data movement 140 for transferring the copied data to the destination process or application. The second data movement 140 may include a phase of transferring the data to the memory which the destination process or application can access in order to send the data obtained through the first data copy 130 to the kernel domain 120.

For the second data movement 140, the second data copy phase 145 is used.

For the communication between processes, domains, or threads, the processor has to perform data copy at least one time and this causes load to the processor. In an embodiment, the task of writing data causes relatively large load to the CPU as compared to the reading task. Accordingly, in order to reduce the load to the CPU, it can be considered to introduce an extra processor responsible for writing task.

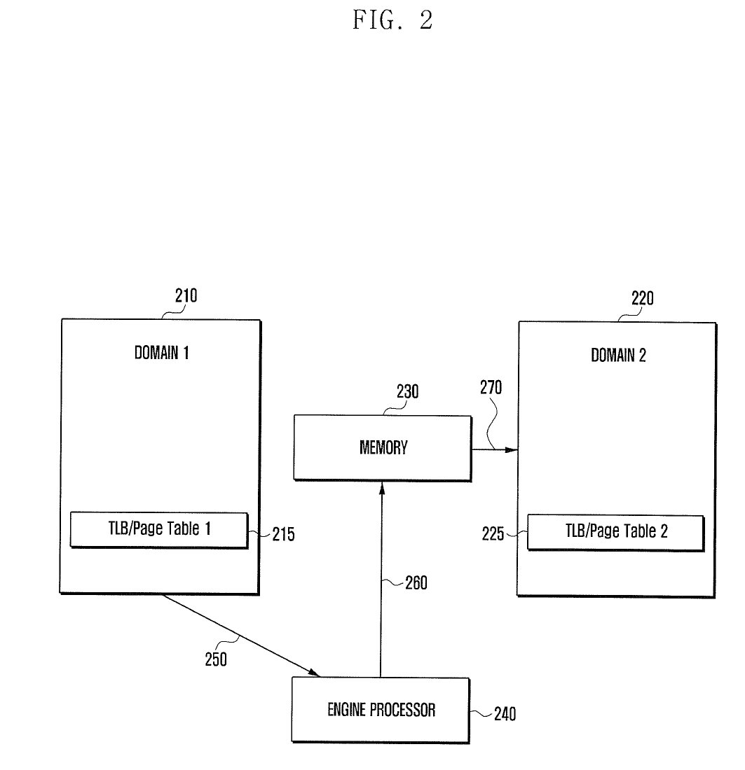

FIG. 2 illustrates a diagram of an inter-domain communication system according to an embodiment of the present disclosure.

Referring to FIG. 2, the first and second domains 210 and 220 can communication with each other. Each domain may be an application or a process. Each domain also may be a guest Operating System (OS) running on a virtual system. In an embodiment, the first domain 210 may transmit data, and the second domain 220 may receive the data transmitted by the first domain 210. The first and second domains 210 and 220 may be executed by the same processor or different processors.

In an embodiment, the inter-domain communication system may include a memory 230 capable of allowing each domain to access for writing or reading data. Each domain may write or read data to and from a certain position or address.

In an embodiment, the first and second domains 210 and 220 may include first and second tables 215 and 225 capable of storing virtual address of the memory accessible and physical address corresponding thereto. Accordingly, the first and second domains 210 and 220 are aware of the virtual addresses of the memory which they can write and read thereto and therefrom and the physical addresses corresponding to the virtual addresses.

According to an embodiment, the address of the memory 230 which each domain is accessible may be restricted. In an embodiment, the second domain 220 cannot access the memory address of the first domain 210 directly for data copy.

In an embodiment, the inter-domain communication system may include an engine processor 240. If a physical address of the memory 230 is received, the engine processor 240 is capable of reading the data written in the memory 230 based on the received physical address. Throughout the specification, the engine processor 240 is referred to as security engine.

If a certain physical address of the memory 230 is received, the engine processor 240 is capable of writing certain data at the corresponding physical address. According to an embodiment, the engine processor 240 can access the addresses of the memory 230 with no limit so as to read data from the entire memory 230. However, the access of the engine processor 240 to the addresses of the memory 230 may be restricted, if necessary, for the purpose of security.

The inter-domain communication system according to an embodiment may include a main processor for controlling the components.

The first domain 210 may translate the virtual address of the memory wherein the target data to be transferred to the second domain 220 to a physical address by referencing the first table 250. The first domain 210 is capable of checking at least one of the physical and virtual addresses on the memory 230 which the second domain 220 can access by referencing the first table 215 or receiving an explicit signal. The explicit signal may include the signal received form the main processor.

The first domain 210 may transmit the first signal to the engine processor 240 as denoted by reference number 250. The first signal may include at least one of the physical source address as the address on the memory 230 storing the data to be transferred, the physical destination address of the memory 230 which the second domain 220 can access and the transferred data can be written, and the size of the data to be transferred. According to an embodiment, the main processor executing the first domain 210 may transmit the first signal to the engine processor 240.

If the first signal is received, the engine processor 240 becomes aware of at least one of the physical source address of the memory 230 of the memory 230 at which the data to be copied is read, the physical destination address of the memory 230 at which the copied data is written, and the size of the data to be copied.

The engine processor 240 may access the memory 230 to copy the data based on one of the physical source and destination addresses and size of the data to be transferred. The engine processor 240 may perform at least one of integrity test and encryption operations on the data copied from the memory 230. The engine processor 240 may write the data processed based on the physical destination address onto the memory 230. Preferably, the engine processor 240 may write the data at the position corresponding to the physical destination address.

According to an embodiment, the engine processor 240 may write copied data onto the physical destination address immediately without performing the above operations.

The second domain 220 may read the data from the address of the memory 230 which it can access based on the second table 225 as denoted by reference number 270. According to an embodiment, the second domain 220 may read the data through a polling or event-based access. The second table 225 may store the information on the mapping between the virtual and physical addresses used by the second domain 220 such that the second domain can access a specific address of the memory 230. According to an embodiment, if the data writing has completed on the memory 230, the engine processor 240 may send the main processor of the computing device a signal including information notifying of the completion of data writing. If this signal is received, the main processor controls the second domain 220 to read the data written on the memory 230. According to an embodiment, the destination to which the signal is transmitted may be the main processor of the computing device or a separate processor capable of performing control operation.

The first domain 210 transfers the data written on the memory 230 which it can access to the second domain 220 through the above procedure, whereby inter-domain communication being accomplished. In an embodiment, the data communication among the domains, the engine processor 240, and the memory 230 may be controlled by the main processor.

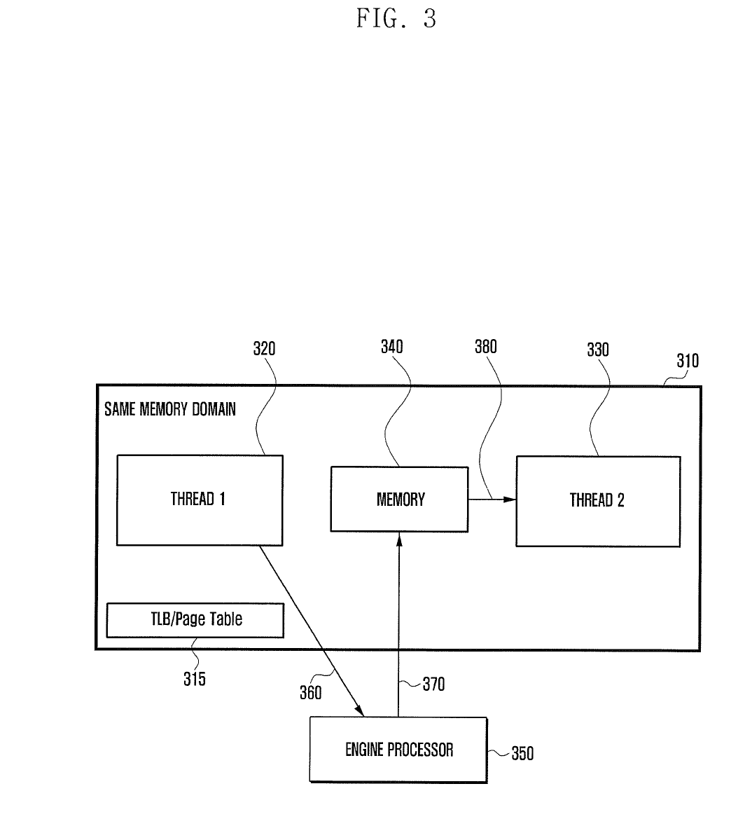

FIG. 3 illustrates a diagram of an inter-thread communication system according to another embodiment of the present disclosure.

Referring to FIG. 3, the first and second threads 320 and 330 may perform data communication in the same memory domain 310. In the embodiment of FIG. 3, the data communication may be controlled by the main processor.

The memory domain 310 may include a table 315. The table 315 may store the information on the mapping between the physical and virtual addresses on the memory 340 which the threads running on the same memory domain 310 can access. Accordingly, the threads running in the same memory domain 310 can translate a virtual address to a physical address based on the table 315. According to an embodiment, the threads running in the same memory domain can access the memory 340 but the physical address regions of the memory 340 which the threads can access may differ from each other.

The first thread 310 may translate the virtual source address on the memory 340 where the data to be transferred to the second thread 320 is stored to the physical source address based on the information stored in the table 315. The first thread 310 also may check the physical source address on the memory 340 which the second thread 310 can access and the information including the size of the data to be transferred. The first thread 310 may send the engine processor 350 the first message including at least one of the physical source address, the physical destination address, and the size of the data to be transferred.

If the first message is received, the engine processor 350 becomes aware of at least one of the physical source address at which the data to be copied is stored on the memory 340, the physical destination address q which the copied data is written on the memory 240, and the size of the data to be copied.

The engine processor 350 may access the memory 340 to copy the data from the memory 340 based on one of the physical source address and the size of the data to be transferred as denoted by reference number 370. The engine processor 350 may perform at least one of integrity test and encryption operations on the data copied from the memory 340. The engine processor 350 may write the data processed based on the physical destination address on the memory 340. Preferably, the engine processor 350 may write the data at the location corresponding to the physical destination address of the memory 340.

According to an embodiment, the engine processor 350 may write the copied data on the memory 340 immediately based on the physical destination address without performing the above operations thereon.

The second thread 330 may read the data from the address of the memory which it can access based on the table 315 as denoted by reference number 380. According to an embodiment, the second thread 320 may read the data through a polling or event-based access. According to an embodiment, the table 315 may store the information including the mapping relationship between the virtual and physical addresses which the second thread 330 uses for access to specific address on the memory 340.

The first thread 320 transfers the data written at the address of the memory 340 which it can access to the second thread 330 through this procedure, whereby inter-domain communication being accomplished. In an embodiment, the data communication among the threads 310 and 320, the engine processor 350, and the memory 340 may be controlled by the main processor.

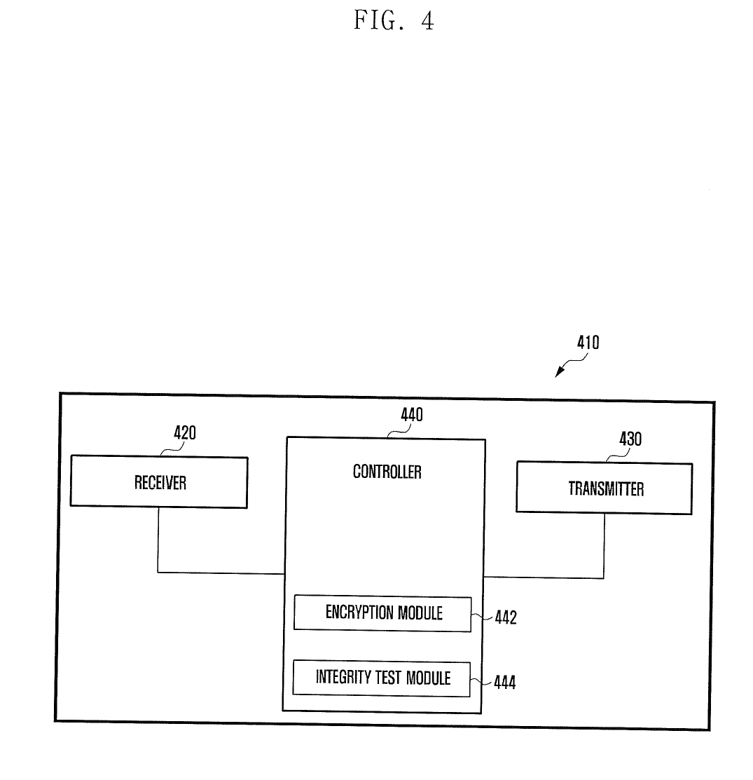

FIG. 4 illustrates a block diagram of a configuration of the computing device according to an embodiment of the present disclosure.

Referring to FIG. 4, the computing device 410 may be an engine processor.

The engine processor 410 may communicate data with at least one of process, thread, application, and memory domain under the control of the main processor of the system. The objects transmitting and receiving data may be referred to as entities.

The engine processor 410 may read or write data on the memory of the system.

In an embodiment, the engine processor 410 may include a receiver 420, a transmitter 430, and a controller 440.

The receiver 420 may receive the data from at least one of the entities. The receiver 420 also may read data from the memory.

According to an embodiment, the receiver 420 may receive a message from at least one of the entities. The message may include at least one of a physical source address at which the data to be copied is stored in the memory, a physical destination address at which the copied data to be written, and the size of the data to be copied. The receiver 420 also may receive the data from the memory. According to an embodiment, the modules for receiving the message and the data may be different from or identical with each other.

The receiver 420 may send the controller 440 at least one of the received message and data.

The controller 440 may control the transmitter 430 to write the data at a specific address of the memory based on the received message.

The controller 440 includes an encryption module 442 for encrypting the received data and an integrity test module for checking the integrity of the received data. According to an embodiment, the integrity test may include at least one of Cyclic Redundancy Check (CRC) test and parity bit check without limit thereto. The encryption may be configured depending on the type of the task.

The transmitter 430 may write the data to the memory under the control of the controller 440. In an embodiment, the receiver 420 may write the data received by the receiver 420 or the data processed by the controller 440 at a specific physical address of the memory based on the received message.

In an embodiment, the receiver 420 may receive a message from at least one of the entities, the message including at least one of the physical source address at which the data to be copied is written, a physical destination address at which the copied data to be written, and the size of the data to be copied. The receiver 420 may receive the data copied from the memory based on the message. The controller 440 may perform at least one of the encryption and integrity test selectively. The transmitter 430 may write the data to be moved on the memory based on the message.

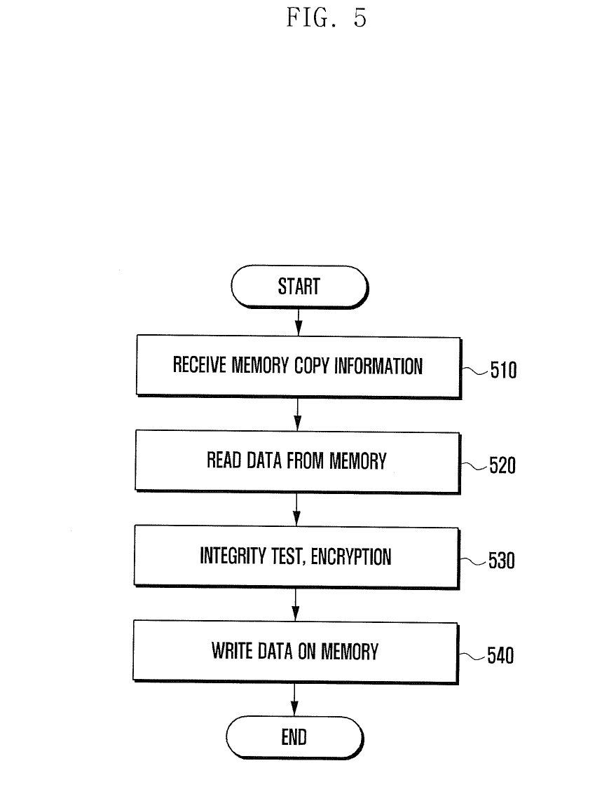

FIG. 5 illustrates a process of the operation procedure of the processor according to an embodiment of the present disclosure.

In an embodiment, the processor may include an engine processor. The main processor of the engine processor system may communicate data with at least one of process, thread, application, and memory domain. The objects transmitting and receiving data may be referred to as entities.

The engine processor receives information on the data to be communication with at least one of the entities at operation 510. In more detail, the engine processor may receive the information including at least one of memory address at which the data to be copied is stored, a memory address at which the copied data to be written, and the size of the copied data. According to an embodiment, the memory address may be a physical address or a virtual address.

The engine processor may read data from the memory based on at least one of the memory addresses at which the data to be copied is stored and the size of the data to be copied at operation 520. In an embodiment, the engine processor may preferably read the data as much as the size of the data to be copied based on the physical address of the memory at which the data to be copied is stored.

The engine processor may perform at least one of integrity test and encryption on the read data selectively at operation 530. According to an embodiment, both the integrity test and encryption may not be performed.

At operation, 540, the engine processor writes the data to which at least one of the integrity test and encryption is performed at operation 530 or the data read from the memory at operation 520 at the destination address. According to an embodiment, the engine processor may write the data passed the integrity test and/or encrypted at operation 530 on the memory based on at least one of the address at which the copied data is to be written and the size of the copied data.

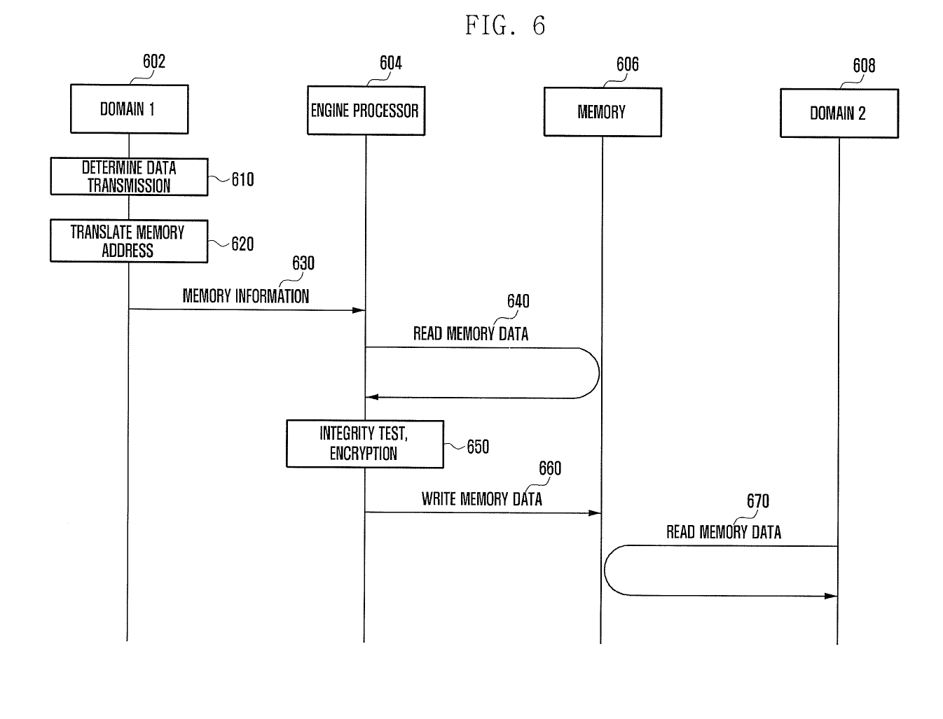

FIG. 6 illustrates a signal flow diagram of signal flows among the components according to an embodiment of the present disclosure.

Referring to FIG. 6, the data communication may be performed between the first and second domains 602 and 608. According to an embodiment, the domains may be substituted for threads or applications. The threads and applications may be controlled by the main processor of the computing device.

The domains may write or read data to and from the memory 606. The domains may check the mapping between the virtual and physical addresses of the data written on the memory 606.

The first domain 602 may determine data transmission at operation 610. At this operation, the information necessary for the data communication may be determined together. The necessary information may include at least one of the source address of the memory 606 where the data to be transferred by the first domain 602 is stored, and the destination address of the memory 606 where the data to be transferred is written, and the size of the data to be transferred. According to an embodiment, the source and destination addresses may include the virtual and physical addresses in the memory 606. Preferably, the source address is a virtual address and the destination address is a physical address.

According to an embodiment, the data transmission may be controlled by the main processor. The first domain 602 may become aware of the virtual address of the memory 606 storing the data to be transmitted. The virtual address may include the address determined by the first domain 602 for access in the memory 606.

The first domain 602 may become aware of the physical source address on the memory based on the virtual source address at operation 620. This operation may be performed based on the information stored in a separate table which the first domain can access, and the separate table may store the information including the mapping relationship between the virtual and physical addresses on the memory 606. In an embodiment, the first domain 602 may translate the virtual source address to the physical source address based on the information stored in the table. The first domain 602 may translate the virtual destination address to the physical destination address selectively based on the information stored in the table.

The first domain 602 may transfer the memory information to the engine processor 604 at operation 630. In an embodiment, the memory information may include at least one of the physical source address on the memory 606 where the data to be transferred is stored, the physical destination address on the memory 606 where the data is to be written, and the size of the data.

At operation 640, the engine processor 604 may read the data from the memory 606 based on the information received at operation 630. In the embodiment, the engine processor 604 may read data from the memory 606 based on at least one of the physical source address and the data size.

At operation 650, the engine processor 604 may perform at least one of integrity test and encryption on the data read at operation 640. According to an embodiment, operation 650 may be performed optionally. It operation 650 is performed, the engine processor 604 performs next operation based on the data read at operation 640.

The engine processor 604 may write the data processed at operation 650 on the memory 606 at operation 660. The data may be written on the memory 606 based on at least one of the physical destination address and the data size received at operation 630.

At operation 670, the second domain 608 may read the data written on the memory at operation 660. According to an embodiment, the data read operation may be performed in a polling or event-based access.

Through the above procedure, the first and second domains 602 and 608 communicate, and the engine processor 604 performs the operating of reading and writing the data to be transferred on the memory instead of the main processor of the computing device so as to mitigate the operation load of the main processor. As a consequence, it is possible to perform inter-domain communication for high speed computation without compromising the performance of the computing device.

According to an embodiment, the engine processor 604 may be an internal module of the main processor or an independent processor implemented independently of the main processor.

As described above, the inter-domain memory copy method and apparatus of the present disclosure is advantageous in reducing CPU load of communication between processes or threads operating at high speed.

Also, the inter-domain memory copy method and apparatus of the present disclosure is advantageous in that a dedicated CPU controls the inter-process or inter-thread communication so as to facilitate data communication and make it possible to perform integrity check and encryption.

Although the present disclosure has been described with an example embodiment, various changes and modifications may be suggested to one skilled in the art. It is intended that the present disclosure encompass such changes and modifications as fall within the scope of the appended claims.

What is claimed is:

1. A method for an engine processor of a computing device to support data communication on a domain, the method comprising:
receiving a signal including at least one of a source address of a memory where data to be transferred is written, a destination address of the memory where the data is to be written, and a size of the data from a main processor which control a transmission domain;
reading the data from the memory based on the received signal; and
writing the read data on the memory based on the received signal.

2. The method of claim 1, further comprising performing at least one of integrity test and encryption on the read data.

3. The method of claim 1, further comprising transferring, when the data is written on the memory completely, a signal notifying the main process of completion of writing the data.

4. The method of claim 1, wherein the reading of the data comprises reading the data as much as data size indicated in the signal received from the main processor from a physical source address of the memory.

5. The method of claim 1, wherein the writing of the data comprises writing the read data as much as data size indicated in the signal received from the main processor at a physical destination address of the memory.

6. An engine processor supporting data communication on a domain in a computing device, the engine processor comprising:
a receiver configured to receive a signal including at least one of a source address of a memory where data to be transferred is written, a destination address of the memory where the data is to be written, and a size of the data from a main processor which control a transmission domain;
a controller configured to control the receiver to read data from the memory based on the received signal; and
a transmitter configured to write the read data on the memory based on the received signal.

7. The engine processor of claim 6, wherein the controller is configured to perform at least one of integrity test and encryption on the read data.

8. The engine processor of claim 6, wherein the controller is configured to control, when the data is written on the memory completely, transferring a signal notifying the main process of completion of writing the data.

9. The engine processor of claim 6, wherein the receiver is configured to read the data as much as data size indicated in the signal received from the main processor from a physical source address of the memory.

10. The engine processor of claim 6, wherein the transmitter is configured to write the read data as much as data size indicated in the signal received from the main processor at a physical destination address of the memory.

11. An inter-domain data communication method in a computing device including a main processor for controlling domains and an engine processor for supporting data communication, the method comprising:
determining data to be transmitted by the main processor controlling a transmission domain;
transmitting a signal including at least one of a source address of a memory where data to be transferred is written, a destination address of the memory where the data is to be written, and a size of the data from the main processor to the engine processor;
reading, at the engine processor, the data from the memory based on the received signal;
writing the data read by the engine processor on the memory based on the received signal; and
reading, at the main processor, the data written by the engine processor on the memory.

12. The method of claim 11, further comprising performing at least one of integrity test and encryption on the data read by the engine processor.

13. The method of claim 11, further comprising transferring, when the data is written on the memory completely, a signal notifying the main process of completion of writing the data from the engine processor to the main processor.

14. The method of claim 13, wherein the reading of the data comprises reading, at the main processor when the signal notifying of completion of writing the data completely is received, the data as much as data size indicated in the signal received from the main processor from a physical source address of the memory.

15. The method of claim 11, wherein the determining of the data to be transmitted comprises translating a virtual source address of the memory where the data to be copied by the main processor is stored to a physical source address.

16. The method of claim 11, wherein the reading of the data comprises reading the data through one of polling and event-based access.

17. A computing device supporting data communication between a plurality of domains, the computing device comprising:
a memory which stores data;
a main processor configured to control at least one of a transmission domain and a reception domain; and
an engine processor configured to perform at least one of reading data stored in the memory or wiring the data on the memory based on a signal received from the main processor,
wherein the main processor controlling the transmission domain is configured to determine the data to be transmitted from the main domain and transmit to the engine processor a signal including at least one of a source address of a memory where the data to be transferred is written, a destination address of the memory where the data is to be written, and a size of the data; and the engine processor is configured to read the data from the memory based on the received signal and writes the read data on the memory based on the received signal; and the main processor controlling the reception domain is configured to read the data written by the engine processor on the memory.

18. A processor device supporting data communication among a plurality of domains, the processor device comprising:
a transmission main processor configured to control a transmission domain and at least one transmission threads;
a memory which is capable of being accessed by the main processor and storing data;
an engine processor configured to transmit a signal including at least one of a source address of a memory where data to be transferred is written, a destination address of the memory where the data is to be written, and a size of the data from a main processor which control a transmission domain, reads data from the memory based on the received signal, and write the read data on the memory based on the received signal; and
a reception main processor configured to control a reception domain to read the data written on the memory and at least one reception thread.
